(19) United States
(12) Patent Application Publication
(10) Pub. No.: US 2026/0268689 A1
(43) Pub. Date: Sep. 10, 2026

(54) DETECTING ANOMALY IN INFORMATION TECHNOLOGY DEVELOPMENT OPERATIONS USING MACHINE LEARNING

(71) Applicant: NEC Laboratories America, Inc., Princeton, NJ (US)

(72) Inventors: Abhishek Aich, San Jose, CA (US); Sparsh Garg, Fremont, CA (US); Manmohan Chandraker, Santa Clara, CA (US)

(21) Appl. No.: 19/553,979

(22) Filed: Mar. 2, 2026

Related U.S. Application Data
(60) Provisional application No. 63/767,026, filed on Mar. 5, 2025.

(51) Int. Cl. G06V 20/58; B60W 60/00; G06T 5/80; G06T 7/20; G06T 7/50; G06T 7/70

(52) U.S. Cl. CPC G06V 20/58; B60W 60/0015; G06T 5/80; G06T 7/20; G06T 7/50; G06T 7/70; G06T 2207/20081; G06V 2201/07

(57) ABSTRACT

Systems and methods for detecting anomaly in information technology development operations using machine learning. Distortion from videos can be removed by rectifying frames from the videos based on estimated camera parameters to obtain rectified videos. A preliminary report of detected anomalies can be generated with an anomaly engine. A structured data file that combines environment data, location data, tracking data, and depth data obtained from the rectified videos can be generated by a summarizing engine. An anomaly report from the preliminary report can be generated by a machine learning model based on an instruction code generated with the structured data file, wherein the anomaly report is used for performing downstream tasks.

### RELATED APPLICATION INFORMATION

This application claims priority to U.S. Provisional App. No. 63/767,026, filed on Mar. 5, 2025, incorporated herein by reference in its entirety.

### BACKGROUND

### Technical Field

The present invention relates to video processing with artificial intelligence (AI) and more particularly detecting anomaly in information technology (IT) development operations using machine learning.

### Description of the Related Art

Artificial intelligence (AI) has been applied to several modalities such as images and videos. For example, with AI, objects can be detected within a scene with low light which would be difficult with a naked eye. This enhances vision of users especially in low light areas or even in scenarios with adverse weather effects such as torrential rain, and blizzards.

### SUMMARY

According to an aspect of the present invention, a method is provided including, removing distortion from videos by rectifying frames from the videos based on estimated camera parameters to obtain rectified videos, generating a preliminary report of detected anomalies with an anomaly engine, generating a structured data file that combines environment data, location data, tracking data, and depth data obtained from the rectified videos by a summarizing engine, and generating an anomaly report from the preliminary report by a machine learning model based on an instruction code generated with the structured data file, wherein the anomaly report is used for performing downstream tasks.

According to another aspect of the present invention, a system is provided, including a memory device, and one or more processor devices operatively coupled with the memory device to perform operations including, removing distortion from videos by rectifying frames from the videos based on estimated camera parameters to obtain rectified videos, generating a preliminary report of detected anomalies with an anomaly engine, generating a structured data file that combines environment data, location data, tracking data, and depth data obtained from the rectified videos by a summarizing engine, and generating an anomaly report from the preliminary report by a machine learning model based on an instruction code generated with the structured data file, wherein the anomaly report is used for performing downstream tasks.

According to yet another aspect of the present invention, a non-transitory computer program product is provided including a computer-readable storage medium including a program code, wherein the program code when executed on a computer causes the computer to perform operations including, removing distortion from videos by rectifying frames from the videos based on estimated camera parameters to obtain rectified videos, generating a preliminary report of detected anomalies with an anomaly engine, generating a structured data file that combines environment data, location data, tracking data, and depth data obtained from the rectified videos by a summarizing engine, and generating an anomaly report from the preliminary report by a machine learning model based on an instruction code generated with the structured data file, wherein the anomaly report is used for performing downstream tasks.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram that shows a computer system for detecting anomaly in information technology development operations using machine learning, in accordance with one embodiment of the present invention;

FIG. 2 is a block diagram that shows a computer system for detecting anomaly in information technology development operations using machine learning, in accordance with an embodiment of the present invention;

FIG. 3 is a block diagram that shows components of a computer system for detecting anomaly in information technology development operations using machine learning, in accordance with an embodiment of the present invention;

FIG. 4 is a block diagram that shows components of a summarizing engine for detecting anomaly in information technology development operations using machine learning, in accordance with an embodiment of the present invention;

FIG. 5 is a block diagram that shows components of an autonomous actor for detecting anomaly in information technology development operations using machine learning, in accordance with an embodiment of the present invention;

FIG. 6 is a flow diagram that shows a high-level overview of detecting anomaly in information technology development operations using machine learning, in accordance with an embodiment of the present invention; and

FIG. 7 is a block diagram that shows a practical application of detecting anomaly in information technology development operations using machine learning, in accordance with an embodiment of the present invention.

### DETAILED DESCRIPTION OF PREFERRED EMBODIMENTS

In accordance with embodiments of the present invention, systems and methods are provided for detecting anomaly in information technology development operations using machine learning.

In an embodiment, distortion from videos can be removed by rectifying frames from the videos based on estimated camera parameters to obtain rectified videos. A preliminary report of detected anomalies can be generated with an anomaly engine. A structured data file that combines environment data, location data, tracking data, and depth data obtained from the rectified videos can be generated by a summarizing engine. An anomaly report from the preliminary report can be generated by a machine learning model based on an instruction code generated with the structured data file, wherein the anomaly report is used for performing downstream tasks.

Modern applications generate and rely on enormous datasets that far exceed what traditional systems were designed to manage. Such datasets are not only large but also complex, often requiring detailed analysis to meet user expectations and business needs. Traditional DevOps methodologies are often inadequate for handling the vast amounts of data and intricate tasks required today, increasing the demands placed on software development and deployment processes.

In particular, exponential growth of visual data from images and videos has necessitated more advanced and automated DevOps pipelines. Industries, such as of autonomous actors, generate vast amounts of visual data to be processed and analyzed for getting reports on system failures or occurrence of unusual activities. This is essential to navigate robustly and improve the underlying system with time. Such a requirement makes the traditional DevOps tools ill-equipped. Not only do they require constant and expensive human intervention, but the generated data is also often unstructured which makes a predefined data model unreliable without extensive preprocessing. This further hampers the ability of organizations to deploy applications that depend on robust data processing, model training, which affects performance and user experience.

To resolve these issues, the present embodiments combine computer vision models with vision-language models (VLMs) to extract detailed, vision-based information from the videos. This visual information is then converted into text and fed into large language models (LLMs) for event analysis. The present embodiments leverage the strengths of vision models to reduce system complexity and computational resource (e.g., processor and memory) utilization for image/video processing by processing complex visual data directly from videos to determine anomalies (e.g., including unusual, particularly long-tail, rare occurrences) which would require extensive training datasets and iterative training to detect. This integration harnesses the power of both visual and language-based processing for more accurate and insightful event analysis.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

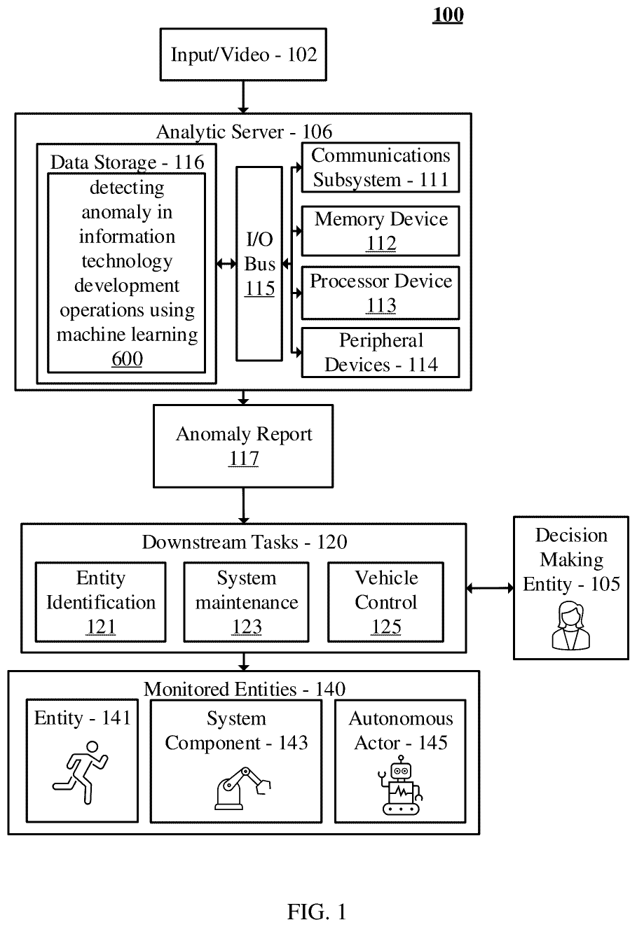

Referring now in detail to the figures in which like numerals represent the same or similar elements and initially to FIG. 1, a block diagram shows a computer system for detecting anomaly in information technology development operations using machine learning, in accordance with one embodiment of the present invention.

In an embodiment using a system 100, monitored entities 140 can include entity 141, system component 143, and autonomous actor 145. The monitored entities 140 can generate a image/video 102. The image/video 102 can be transmitted to an analytic server 106 that can implement detecting anomaly in information technology development operations using machine learning 600. The analytic server 106 can generate an anomaly report 117 which can be utilized to perform downstream tasks 120.

System 100 can be utilized to perform downstream tasks 120 based on the image/video 102 and user query 104 from a decision-making entity 105. The downstream tasks 120 can include entity identification 121, system maintenance 123, and vehicle control 125. The analytic server 106 can generate a corrective action for the downstream tasks 120 to be sent to respective computing systems for the monitored entities 140 through a network.

In entity identification 121, the image/video 102 or text description 103 (e.g., location images, scene images, entity images such as parts of the entity, etc.) related to the entity 141 can be processed by the analytic server 106 to answer user query 104 based on the anomaly report 117 by the analytic server 106. The user query 104 can be relevant to the entity 141 such as their attributes (e.g., position, direction of movement, color of clothing, etc.), relationship with other entities within a scene (e.g., proximity, behavior, etc.), relationship with the environment, etc. The analytic server 106 can predict future attributes, and relationships of the entity 141.

Based on the predictions of the analytic server 106, a corrective action can be generated by the analytic server 106. The corrective action can include notifying the decision making entity 105 of the predictions about the entity 141 based on their image/video 102, generating resolutions to an issue caused by the entity (e.g., the entity 141 as a disabled vehicle in a traffic scene and the resolution is the deployment of a repair technician, etc.) of the image/video 102 to help with the decision making process of the decision making entity 105, etc.

In system maintenance 123, image/video 102 related to the system component 143 can be processed to answer user query based on based on the anomaly report 117 for the system component 143 generated by the analytic server 106. The user query 104 can be relevant on how to properly maintain the system component 143, or whether the system component is properly functioning based on the input image/video 102. A corrective action can be generated by the analytic server 106 which can include the answer to the user query (e.g., determine causes to bandwidth issues, etc.) to maintain the system component 143. Based on the corrective action (e.g., adding bandwidth, blocking packets from an identified internet protocol (IP) address to resolve malicious attacks, restarting hardware, redirecting processing of component, etc.) the network system can be autonomously maintained.

In vehicle control 125, image/video 102 (e.g., vehicle part status, traffic scene image, etc.) related to the autonomous actor 145 (e.g., autonomous vehicle) can be processed to answer user query. The user query 104 can be relevant to how to control the autonomous actor 145 given its environment based on the image/video 102 or text description 103. A corrective action can be generated by the analytic server 106 which can include the answer to the user query to control the proper performance of the autonomous actor 145. Based on the corrective action (e.g., stopping, speeding up, changing direction, etc.) the autonomous actor 145 can be autonomously controlled using appropriate control devices (e.g., advanced driver assistance systems, braking device, accelerator device, cooling device, etc.) within the autonomous actor. In an embodiment, the autonomous actor 145 can be controlled in response to avoid a predicted event based on a generated trajectory based on the anomaly report 117 generated by the analytic server 106 such as multi-vehicle collision, accidents, detected road hazards, etc.

In another embodiment, in vehicle control 125, the autonomous actor 145 can be controlled to verify and test the functionality of the various components (e.g., advanced driver assistance systems, braking device, accelerator device, cooling device, etc.) of the autonomous actor 145 by autonomously controlling the components and generate training data.

Other downstream tasks and practical applications are contemplated.

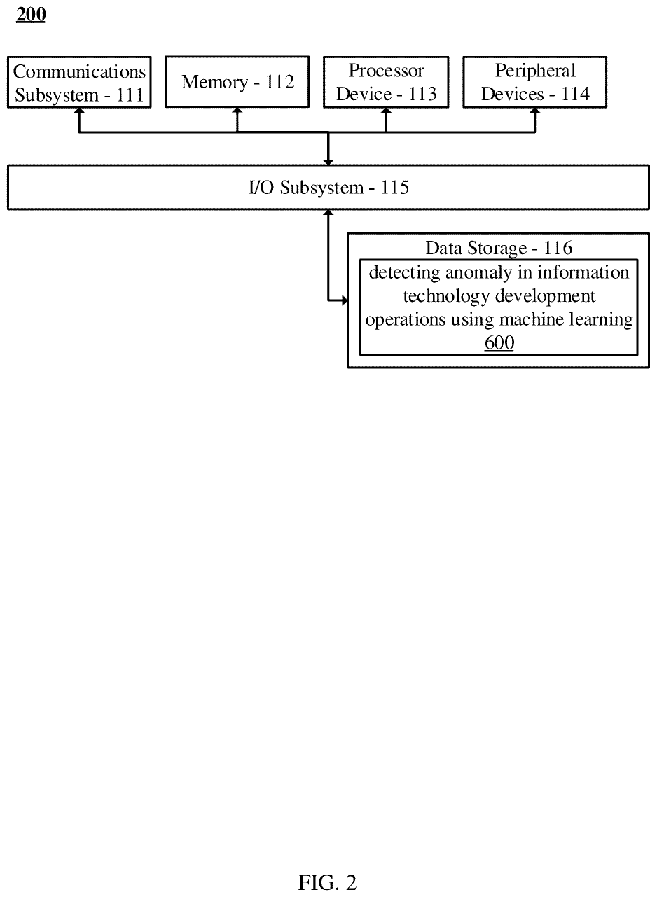

The analytic server 106 can include a processor device 113, data storage device 116, memory 112, communications subsystem 111, peripheral devices 114, and input/output (I/O) bus 115. The analytic server 106 is an implementation of a computer system. Other implementations are contemplated. The computer system is shown in more detail in FIG. 2.

Referring now to FIG. 2, a block diagram that shows a computer system for detecting anomaly in information technology development operations using machine learning, in accordance with an embodiment of the present invention.

The computing device 200 illustratively includes the processor device 113, an input/output (I/O) subsystem 190, a memory 112, a data storage device 116, and a communications subsystem 111, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 112, or portions thereof, may be incorporated in the processor device 113 in some embodiments.

The processor device 113 may be embodied as any type of processor capable of performing the functions described herein. The processor device 113 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 112 may be embodied as any type of volatile or non-volatile memory or data storage capable of performing the functions described herein. In operation, the memory 112 may store various data and software employed during operation of the computing device 200, such as operating systems, applications, programs, libraries, and drivers. The memory 112 is communicatively coupled to the processor device 113 via the I/O subsystem 115, which may be embodied as circuitry and/or components to facilitate input/output operations with the processor device 113, the memory 112, and other components of the computing device 200. For example, the I/O subsystem 115 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 115 may form a portion of a system-on-a-chip (SOC) and be incorporated, along with the processor device 113, the memory 112, and other components of the computing device 200, on a single integrated circuit chip.

The data storage device 116 may be embodied as any type of device or devices configured for short-term or long-term storage of data such as, for example, memory devices and circuits, memory cards, hard disk drives, solid state drives, or other data storage devices. The data storage device 116 can store program code for detecting anomaly in information technology development operations using machine learning 600. Any or all of these program code blocks may be included in a given computing system.

The communications subsystem 111 of the computing device 200 may be embodied as any network interface controller or other communication circuit, device, or collection thereof, capable of enabling communications between the computing device 200 and other remote devices over a network. The communications subsystem 111 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 200 may also include one or more peripheral devices 114. The peripheral devices 114 may include any number of additional input/output devices, interface devices, and/or other peripheral devices. For example, in some embodiments, the peripheral devices 114 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing device 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

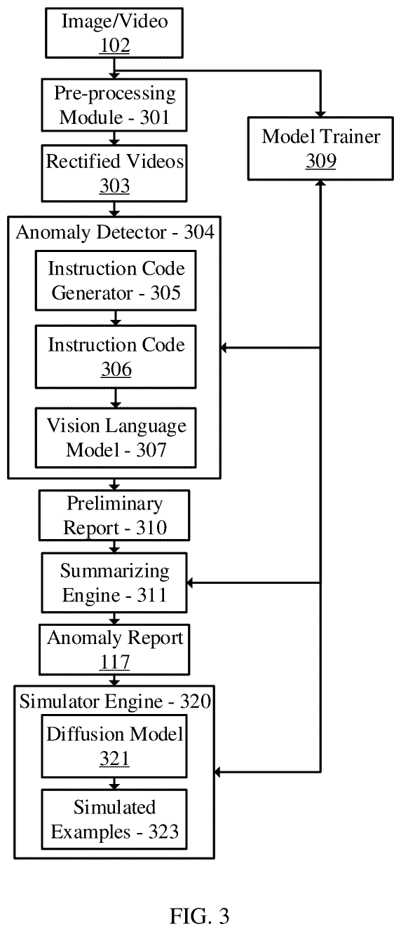

Referring now to FIG. 3, a block diagram shows components of a computer system for detecting anomaly in information technology development operations using machine learning, in accordance with an embodiment of the present invention.

In an embodiment, image/video 102 can be processed by a pre-processing model 301 to obtain rectified videos 303. The pre-processing model 301 can include a camera-pose estimation model. The rectified videos 303 can be processed by the anomaly detector 304 to generate a preliminary report 310. The preliminary report 310 can be processed by a summarizing engine 311 to generate an anomaly report 117. The anomaly report 117 can be processed by the simulator engine 320 to generate simulated examples 323 which include new examples of input/videos 102.

The anomaly detector 304 can include an instruction code generator 305 that can generate instruction code 306 from the image/video 102 to instruct a vision-language model 307 to generate the preliminary report 310. The vision language model 307 can analyze the overall context of the video to extract environment data such as weather conditions, road structure, and the presence of different objects in the scene. This allows for a more holistic interpretation of the environment, supporting diverse reasoning tasks.

In an embodiment, the simulator engine 320 can include a diffusion model 321 can process the anomaly report 117 and the image/videos 102 to generate simulated examples 323 that modifies aspects of the image/videos 102. The model trainer 309 can train the diffusion model 321 to generate the simulated examples 323.

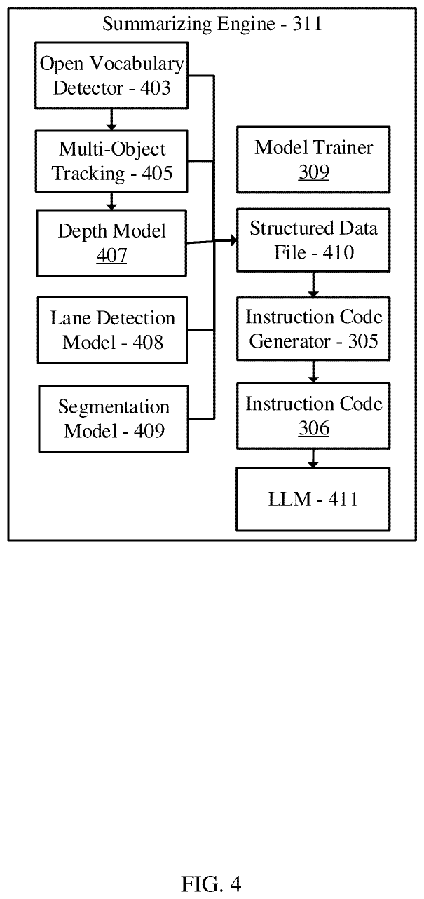

Referring now to FIG. 4, a block diagram shows components of a summarizing engine for detecting anomaly in information technology development operations using machine learning, in accordance with an embodiment of the present invention.

In an embodiment, image/video 102 can be processed by a summarizing engine 311 to generate an instruction code 333 to instruct a large language model (LLM) 340 to generate the anomaly report 117.

The summarizing engine 311 can include an open vocabulary detector 403, multi-object tracker 405, depth model 407, lane detection model 408, and segmentation model 409. The model trainer 309 can train the vision language model 307, an open vocabulary detector 403, multi-object tracker 405, depth model 407, lane detection model 408 and segmentation model 409 with the image/video 102. The open vocabulary detector 403, multi-object tracker 405, depth model 407, lane detection model 408, and segmentation model 409 can utilize neural networks.

The open vocabulary detector 403 can identify and localize objects into location data such as hardware components, such as routers, computing nodes, servers, etc., within the image frame, serving as the foundation for scene analysis and object tracking.

The multi-object tracker 405 can include three dimensional (3D) object detection estimates the real-world spatial location, dimensions, and orientation of objects, utilized for understanding their movement and interactions within the environment.

Depth model 407 can obtain depth data which can estimate the distance of each detected object relative to the sensors that obtain the image/video 102, aiding in assessing collision risks and spatial reasoning for downstream applications. The lane detection model 408 detects lanes on a road with the segmentation model 409.

The summarizing engine 311 combines the environment data, location data, tracking data and depth data to generate a structured data file 410. The structured data file 410 can be converted into natural language by the summarizing engine 311 to enable the instruction code generator 331 to generate the instruction code 333.

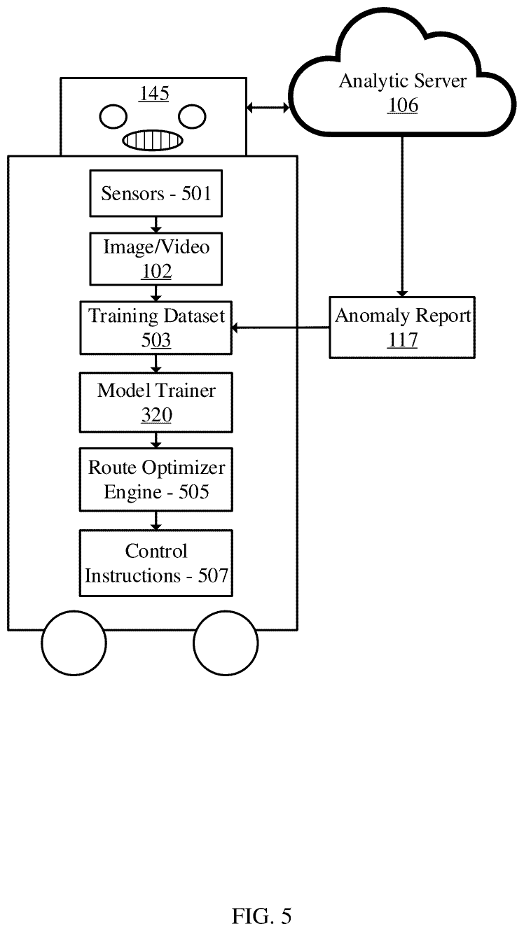

Referring now to FIG. 5, a block diagram shows components of an autonomous actor for detecting anomaly in information technology development operations using machine learning, in accordance with an embodiment of the present invention.

In an embodiment, autonomous actor 145 can generate control instructions 507 to control itself with steering, braking, and accelerating systems such as advanced driver assistance system (ADAS). The route optimizer engine 505 of the autonomous actor 145 can generate the control instructions 507 based on obtained image/video 102 by the sensors 501 of the autonomous actor 145.

In another embodiment, image/video 102 obtained by the sensors 501 can be utilized with the anomaly report 117 from the analytic server 106 to generate a training dataset 503 to train the route optimizer engine 505. The model trainer 309 can train the route optimizer engine 505 continuously as new image/video 102 is obtained in real time. The autonomous actor 145 can process user queries provided by a decision making entity 105 (e.g., driver, passenger, owner, etc.).

The route optimizer engine 505 can utilize reinforcement learning to generate the control instructions 507 to avoid a detected undesirable event (e.g., collision). The autonomous actor 145 can generate corrective actions depending on the detected anomalies based on the anomaly report 117. The route optimizer engine 505 can utilize neural networks.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network, such as a multilayer perceptron, can have an input layer of source neurons, one or more computation layer(s) having one or more computation neurons, and an output layer, where there is a single output neuron for each possible category into which the input example could be classified. An input layer can have a number of source neurons equal to the number of data values in the input data. The computation neurons in the computation layer(s) can also be referred to as hidden layers, because they are between the source neurons and output neuron(s) and are not directly observed. Each neuron in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

Training a deep neural network can involve two phases, a forward phase where the weights of each neuron are fixed and the input propagates through the network, and a backwards phase where an error value is propagated backwards through the network and weight values are updated. The computation neurons in the one or more computation (hidden) layer(s) perform a nonlinear transformation on the input data that generates a feature space. The classes or categories may be more easily separated in the feature space than in the original data space.

In an embodiment, the model trainer 309 can train the route optimizer engine 505 with reinforcement learning where a state of the environment can be determined by the model trainer 309 and actions (e.g., simulations of actor movement including trajectories, performance of corrective actions, etc.) of the route optimizer engine 505 can be generated based on the state. Rewards can be provided if the actions result in a good outcome (e.g., avoidance of collisions, shorter total distance travelled, etc.). Penalties can be provided if the actions result in a bad outcome (e.g., resulted in collisions, inefficient route taken, issue persistence even after corrective action, etc.). The model trainer 309 trains the route optimizer engine 505 such that rewards are maximized and penalties are minimized.

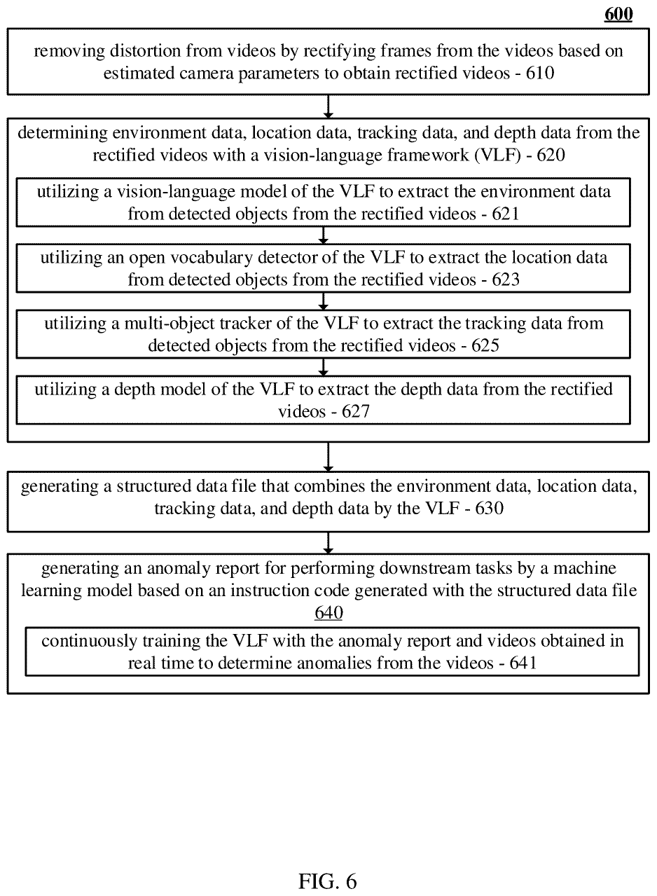

Referring now to FIG. 6, a flow diagram shows a high-level overview of detecting anomaly in information technology development operations using machine learning, in accordance with an embodiment of the present invention.

In an embodiment, distortion from videos can be removed by rectifying frames from the videos based on estimated camera parameters to obtain rectified videos. A preliminary report of detected anomalies can be generated with an anomaly engine. A structured data file that combines environment data, location data, tracking data, and depth data obtained from the rectified videos can be generated by a summarizing engine. An anomaly report from the preliminary report can be generated by a machine learning model based on an instruction code generated with the structured data file, wherein the anomaly report is used for performing downstream tasks.

In block 610, distortion from videos are removed by rectifying the video frames from the videos based on estimated camera parameters to obtain rectified videos. In an embodiment, distortions can be removed by rectifying the video frames from the videos 102 based on estimated camera parameters. Videos 102 obtained from the front side of vehicles often suffer from distortions due to the characteristics of front-facing cameras. To correct these distortions, the video frames can be rectified based on estimated camera parameters. The camera parameters can include the focal length, optical center, and rotation matrix of the camera used to obtain the videos 102 can be estimated. A vector that models radial distortion and tangential distortion, and the translation vector can be estimated. To rectify the video frames, checkerboard calibration can be utilized. In another embodiment, feature-based analysis can be utilized.

The rectified video 303 can be obtained by: I(x, y)=I_{d}(R⁻¹(x, y)), (2) where R⁻¹(x, y) computes the corresponding distorted coordinates for each undistorted pixel location (x, y) using the estimated camera intrinsic matrix and distortion coefficients.

Once the frames are undistorted, a multi-task function, denoted as [symbol] , processes the video and extracts structured outputs that provide a comprehensive understanding of the scene. Let an image/video 102 be represented as a sequence of T frames: v=(I₁, I₂, . . . , I_{T}) where each frame Iₜ Σ [symbol] is the t-th RGB image of height H and width W. By extracting these structured elements, the summarizing engine 311 enables robust scene interpretation in complex and dynamic environments. The structured output for each frame Iₜ can include environment data, location data, tracking data, and depth data based on a state for the ego-actor.

In an embodiment, the state for the ego-actor can be estimated. To do so, a camera-pose estimation model F_{cam-pose} can be utilized to map video frames V to a sequence of translation vectors

$${\{ {T}_{t} \}}_{t = 1}^{T} ,$$

Where Tₜ=(Xₜ, Yₜ, Zₜ) ∈ [symbol] denotes the camera position at time t. The state can include turning and motion estimations.

To estimate the turning movement, with (Xₜ, Zₜ)∇t ∈ {1, . . . , T}, the heading angle of the camera Δθᵢ can be estimated as Δθₜ=tan⁻¹(Zₜ₊₁−Zₜ/Xₜ₊₁-Xₜ)−tan⁻¹ (Zₜ-Zₜ₋₁/Xₜ-Xₜ₋₁). Next, Δθₜ can be used to classify the actor's turn into the three categories (τ_{α} as a threshold) as Dₜᵤᵣₙ= “Straight” if |Δθₜ|<τ_{α}, “Right Turn” if Δθₜ>τ_{α}, else “Left Turn”.

To estimate the motion, the actor's motion over a temporal window g can be computed using sₜ=∥T_{t+g}−Tₜ∥/g, ∇t ∈ {1, . . . , T-g}, where sₜ denotes the approximate speed at time t, used to classify the vehicle's motion state as Dₘₒₜᵢₒₙ=“Stopped” if sₜ<τₛ, else “Moving” where τₛ represents the speed threshold for detecting a stopped vehicle. By incorporating both turning and motion status, the state of the ego-actor can be structured as F_{ego}:

$${\{ ( {I}_{t} , {T}_{t} ) \}}_{t = 1}^{T} \to ( {D}_{motion} , {D}_{turn} ) .$$

Fine-grained detail determination can then be performed after determining the state of the ego-actor.

In block 620, a preliminary report of detected anomalies within videos can be generated with an anomaly engine. In an embodiment, the anomaly detector 304 can generate preliminary report 310 that provide an initial, high-level response to user queries based on raw visual input. Additionally, the anomaly detector 304 can expose limitations in generic models leading to incorrect explanations. The anomaly detector 304 can be queried using the original video V and extract its response as preliminary report 310 Dₚₑₑᵣ. The anomaly detector 304 can utilize an instruction code generator 305 to generate instruction code 306 to instruct vision-language model 307 to generate the preliminary report 310. This response is treated as a first-pass hypothesis, which can be verified using the structured data file 410. For example, the instruction code 306 can include “What is the unusual event in this scene? Explain the possible reasons.”

In block 630, the preliminary report can be verified by generating a structured data file that combines the environment data, location data, tracking data, and depth data obtained by a summarizing engine.

In an embodiment, the preliminary report 310 can be verified by generating a structured data file 410. Inconsistent findings from the preliminary report 310 with the structured data file 410 can be disregarded and consistent findings (e.g., similar findings within a threshold) can be stored and utilized.

In an embodiment, the structured data file 410 can be generated by combining fine-grained details from the rectified videos 303 including environment data, location data, tracking data, and depth data. In an embodiment, environment data, location data, tracking data, and depth data from the rectified videos can be determined with a summarizing engine 311.

In an embodiment, the summarizing engine 311 can extract vision grounded information including environment data, location data, tracking data, and depth data from a batch of multiple vision models from the input data in a frame-by-frame manner.

In block 631, environment data can be extracted from the rectified videos by utilizing a vision-language model. In an embodiment, the vision language model 307 can analyze the overall context of the rectified video to extract environment data such as weather conditions, road structure, and the presence of different objects in the scene. This allows for a more holistic interpretation of the environment, supporting diverse reasoning tasks.

In block 633, location data can be extracted from the rectified videos by utilizing an open vocabulary detector. In an embodiment, the open vocabulary detector 403 can obtain location data 313 from the rectified videos 302. The open vocabulary detector 403 can identify and localize objects such as vehicles and pedestrians within the image frame, serving as the foundation for scene analysis and object tracking.

The location data 313 can include two-dimensional (2D) bounding boxes and labels for the objects detected within the rectified videos 302. Two-dimensional (2D) bounding boxes that provide positions of the detected objects can be extracted from the rectified videos with the open vocabulary detector 403. Labels for the detected objects can be extracted from the rectified videos with the open vocabulary detector 403.

In an embodiment, the 2D bounding boxes and labels for the detected objects can be represented as

$${B}_{t} = {\{ ( {b}_{t , i} , {c}_{t , i} ) \}}_{i = 1}^{{n}_{t}}$$

where b_{t,i} ∈ [symbol] is a 2D bounding box parameterized by (xₘᵢₙ, yₘᵢₙ, xₘₐₓ, yₘₐₓ), and c_{t,i} denotes the object class for the i-th detected object in frame t. The location data 313 can include lane markings.

To detect the lane markings from the rectified videos 302, a lane detection model 408 Fₗₐₙₑ can be utilized and obtain the predicted lane markings in each frame Iₜ as and mₜ is the total number of detected lane markings. The road can then be divided into

$${F}_{lane} ( {I}_{t} ) : ( {I}_{t} ) \to {\{ {l}_{t , j} \}}_{j = 1}^{{m}_{t}} ,$$

where, l_{t,j} represents the set of j-th lane marking coordinates, and mₜ is the total number of detected lane markings. The road can then be divided into mₜ+1 number of lane sections formed by the lane markings. Each lane section is now defined as S_{t,k}={(x, y)|xₗ_{_{t,j}}≤x≤xₗ_{_{t,j+1}},y=[y_{max,L}_{ₜ},H]}, where xₗ_{_{t,j}} is the x-coordinate of the j-th lane marking, y_{max,L}_{ₜ}=minⱼyₗ_{_{t,j}} is the highest point of all lane markings (assuming image coordinates have the origin at the top-left).

For each ith object in frame t, the midpoint p_{t,i} of its bounding box bottom edge can be computed as p_{t,i}=((xₘᵢₙ+xₘₐₓ)/2,yₘₐₓ). Then, its lane λ_{t,i} is estimated as λ_{t,i}=k such that p_{t,i} ∈ S_{t,k}.

The ego-actor's lane λ_{t,ego} can be estimated using the bottom-center pixel p_{t,ego}=(W/2, H) as a reference. The resulting lane data is then added to structured data file 410 for each frame as Fₗₐₙₑ:

$$( {I}_{t} , {K}_{t} ) \to ( {\{ {λ}_{t , i} \}}_{i = 1}^{{n}_{t}} , {λ}_{t , ego} ) .$$

In block 635, tracking data can be extracted from the rectified videos by using the multi-object tracker. In an embodiment, the tracking data 315 can include that tracks of detected objects within the rectified videos 302 across different frames. The tracks can include 2D bounding boxes and class labels of the detected objects.

In block 637, depth data of detected objects can be determined from the rectified videos with a depth model. In an embodiment, the depth data 317 of detected objects can be determined. The depth can include per-object distance from the camera which can be represented as:

$${D}_{t} = {\{ ( {d}_{t , i} ) \}}_{i = 1}^{{n}_{t}} ,$$

where d_{t,i} ∈ [symbol] denotes the distance from the dash-cam to the i-th detected object.

Given an input frame Iₜ, a depth estimation model 407 F_{depth} predicts a metric depth map F_{depth}: (Iₜ)→Dₜ where, Dₜ ∈ [symbol] is the estimated depth map for frame t. For ith object's bounding box b_{t,i}=(xₘᵢₙ, yₘᵢₙ, xₘₐₓ, yₘₐₓ), the cropped depth region corresponding to the object is D_{t,i}=Dt[xₘᵢₙ: xₘₐₓ>yₘᵢₙ: yₘₐₓ]. Next, to make the region of the object more precise and eliminate any background pixel, a segmentation model 409 F_{seg} predicts a binary mask M_{t,i} for the object within b_{t,i}. The final distance d_{t,i} of the object from the ego-actor is computed as the mean distance of the masked region. d_{t,i}=mean (D_{t,i}⊙M_{t,i}), where ⊙ denotes the element-wise multiplication. Finally, the distance information per object per frame is added to structured data file 410 as follows: F_{dist}:

$$( {I}_{t} , {K}_{t} ) \to {\{ {d}_{t , i} \}}_{i = 1}^{{n}_{t}} .$$

In an embodiment, three-dimensional bounding boxes can be extracted from detected objects with depth data 317. For objects with depth information, the position is defined as:

$${P}_{t} = {\{ ( {p}_{t , i} , {c}_{t , i} ) \}}_{i = 1}^{{n}_{t}} ,$$

where p_{t,i} ⊂ [symbol] describes the 3D position and orientation of the bounding box in the scene, parameterized as (X, Y, Z, l, w, h, θ), in a chosen coordinate frame (camera centered or world centered), and c_{t,i} represents the object class. Using a 3D detection model F_{3D-det}, 3D bounding boxes Pₜ can be predicted and extract the yaw θ_{t,i} ∈ [−π, π] for each object as F_{3D-det}:

$$( {I}_{t} ) \to {\{ {θ}_{t , i} \}}_{i = 1}^{{P}_{t}} .$$

Each 3D bounding box can be projected into 2D image space using the camera intrinsic matrix. The projected boxes can be matched to detected objects with a combinatorial optimization algorithm such as the Hungarian algorithm and transfer θ_{t,i} to the corresponding local object.

In an embodiment, a structured data file 410 that combines the environment data, location data, tracking data, and depth data can be generated.

In an embodiment, the structured data file 410 for each frame t can be written as Yₜ=(Bₜ, Pₜ, Lₜ, Dₜ). The structured data file 410 can be written in a structured data representation such as extensible markup language (XML), javascript object notation (JSON), etc.

The structured data file 410 can include a video-level section, an object level section and a frame level section. The video level section can include the environment data. The object level section can include the granular information about the detected objects. The frame level section can include information about the frames of the rectified videos. For example, the structured data file 410 can include a video level section that can include: “weather: ‘sunny’, light: ‘day/night’, linear: ‘arterials/curve/intersection/T-junction/ramp’, environment: ‘city street/country road/highway/residential area’”. The object level section and frame level section can include “Objects: [{track id: 1, class: ‘car’, per frame info: [{frame id: 24, bbox: [*, *, *, *], score: 0.5, depth: 16}, { }, desc: [{description: ‘a dark-colored car . . . ’, view: ‘font’} . . . ]}]”

The overarching function applied to the videos 102 can be represented as:

$$ℱ : {ℝ}^{T \times H \times W \times 3} \to {\prod }_{t = 1}^{T} ( ℬ \times 𝒫 \times ℒ \times 𝒟 )$$

such that, [symbol] (v)=Y₁,Y₂ . . . Yₜ) where, Yₜ=(Bₜ, Pₜ, Lₜ, Dₜ). Function [symbol] is conceptualized as a single function

$${\{ ( {B}_{t} , {P}_{t} , {L}_{t} , {D}_{t} ) \}}_{i = 1}^{{n}_{t}}$$

that takes in input videos and outputs a suite of perception results.

In an embodiment, an instruction code 306 can be generated based on the structured data file 410 to instruct a machine learning model (e.g., LLM 411) to determine anomalies from the structured data file 410. In an embodiment, an instruction code 306 can be generated by the instruction code generator 305 to instruct a machine learning model such as LLM 411 to determine anomalies (e.g., including unusual, particularly long-tail, rare occurrences) in videos 102.

In an embodiment, the instruction code 306 can include sections on how the LLM 411 can determine the anomalies such as prerequisites, heuristics to utilize, output specification, input specification, etc. The instruction code 306 can include an explanation section which provides a precise and explicit interpretation of the scene representation D, reducing ambiguity in the model's input. The instruction code 306 can include sub-goal sections which decomposes the reasoning task into explicit sub-goals. The instruction code 306 can include peer instruction section which informs the model that peer-generated answers may be unreliable and explicitly encourages independent reasoning.

In block 640, an anomaly report for performing downstream tasks can be generated by the machine learning model based on an instruction code generated with the structured data file.

In an embodiment, a machine learning model such as LLM 411 can be utilized to generate an anomaly report 117. The anomaly report 117 can include an issue section and a cause section. The issue section describes the anomaly detected within the videos 102. The cause section describes a logical reason as to how the anomaly detected happened within the context of the video. For example, in an image/video 102 showing a request time-out when accessing a distributed application, the issue section can include “a request time-out when accessing a distributed application.” The cause section can include “the distributed application has excessive requests from an IP address which limited bandwidth to the user accessing the distributed application.”

In an embodiment, a training dataset 503 can be generated with data from the anomaly report 117, the structured data file 410, and image/videos 102 obtained in real time. The analytic server 106 can process data from the anomaly report 117, the structured data file 410, and videos 102 to generate the training dataset 503.

In an embodiment, the training dataset 503 can be generated with the simulator engine 320. The simulator engine 320 can process the anomaly report 117 and/or the structured data file 410 as input. Then, a control-net based diffusion model 321 of the simulator engine 320 can generate simulated examples 323 by utilizing an instruction code 306 having specific descriptions in a scene. The simulated examples 323 can include newly generated scenes using the structured data file 410. The simulated examples 323 can also include modified details about the scene described by the structured data file 410.

In block 641, a model trainer 309 can be implemented within the autonomous actors 145 to generate the training dataset 503. The training dataset 503 can be utilized by the model trainer 309 to continuously train a route optimizer engine 505 of the autonomous actor 145 to generate control instructions 507 for the autonomous actor 145. The route optimizer engine 505 can utilize knowledge from summarizing engine 311. The individual machine learning models of summarizing engine 311 and the route optimizer engine 505 can be trained independently. In another embodiment, the models can be trained in a joint learning framework.

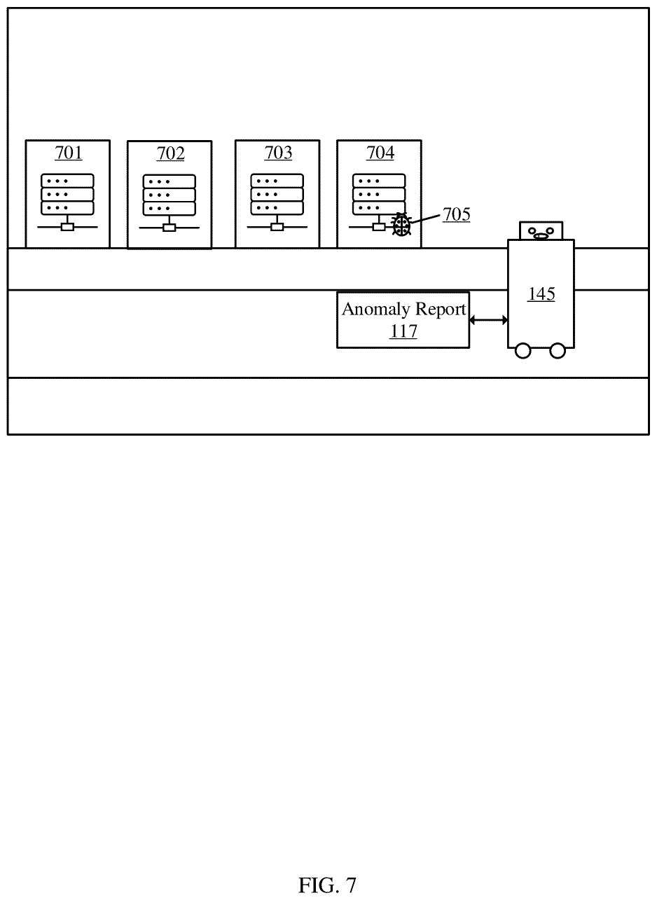

Referring now to FIG. 7, a block diagram shows a practical application of detecting anomaly in information technology development operations using machine learning, in accordance with an embodiment of the present invention.

In an embodiment, in IT environment 700, autonomous actor 145 can communicate analytic server 106 through a network. Input videos 102 can be processed by the autonomous actor 145 through the analytic server 106 through the network.

The autonomous actor 145 can autonomously understand the IT environment 700 and generate anomaly report 117 based on the IT environment 700. The anomaly report 117 can include predictions of anomalies within servers 701, 702, 703, and 704. For example, anomaly 705 (e.g., physical issue such as unplugged routers, uncoupled connectors, etc.) of the servers 701, 702, 703, and 704 in the IT environment 700 based on user queries. The autonomous actor 145 can include an AI agent that can interact with decision making entity 105 and process user queries. For example, the user queries provided by the decision making entity 105 to the autonomous actor 145 can include “are the servers operational?” The autonomous actor 145 can generate an anomaly report 117.

In another embodiment, autonomous actor 145 can process image/videos 102 of software code being developed and maintained. The autonomous actor 145 can detect anomalies from the software code such as code potentially exploitable by malicious code which can hinder operation of the enterprise application such as cross-site scripting attacks, distributed denial of service attacks. Based on the detected anomalies, autonomous actor 145 can generate control instructions to resolve the issues such as patching the code, blocking IP address of anomalous requests, etc. through autonomous decision making.

The autonomous actor 145 can process the input videos 102 and generate control instructions 507 and control the autonomous actor 145 based on input queries and anomaly report 117 through autonomous decision making. The anomaly report 117 can include an issue section describing “which can include “No, server (704) is not operational with temperature in normal conditions. The cause section of the anomaly report 117 can include “Server 704 includes an anomaly wherein router 1 is unplugged.” In an embodiment, the autonomous actor 145 can be controlled to plug in router 1.

In another embodiment, IT environment 700, autonomous actor 145 can generate simulated examples 323 examples for the identified anomalies. For example, in videos monitoring logs of IT environment 700, simulated examples 323 can include instances of excessive access from an IP address. In another embodiment, in IT environment 700, based on the simulated trajectories of the identified entities, autonomous actor 145 can generate a trajectory that checks all servers within a target time and a target fuel/battery consumption.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
removing distortion from videos by rectifying frames from the videos based on estimated camera parameters to obtain rectified videos;
generating a preliminary report of detected anomalies with an anomaly engine;
generating a structured data file that combines environment data, location data, tracking data, and depth data obtained from the rectified videos by a summarizing engine; and
generating an anomaly report from the preliminary report by a machine learning model based on an instruction code generated with the structured data file, wherein the anomaly report is used for performing downstream tasks.

2. The method of claim 1, wherein generating the structured data file further comprises utilizing a vision-language model of the summarizing engine to extract the environment data from detected objects from the rectified videos.

3. The method of claim 1, wherein generating the structured data file further comprises utilizing an open vocabulary detector of the summarizing engine to extract the location data from detected objects from the rectified videos.

4. The method of claim 1, wherein generating the structured data file further comprises utilizing a multi-object tracker of the summarizing engine to extract the tracking data from detected objects from the rectified videos.

5. The method of claim 1, wherein generating the structured data file further comprises utilizing a depth model of the summarizing engine to extract the depth data from the rectified videos.

6. The method of claim 1, further comprising continuously training the summarizing engine with the anomaly report and simulated examples generated from videos obtained in real time by a simulation engine.

7. The method of claim 1, further comprising controlling an autonomous actor to resolve issues caused by anomalies detected based on the anomaly report through autonomous decision making.

8. A system, comprising:
a memory device; and
one or more processor devices operatively coupled with the memory device to perform operations including:
removing distortion from videos by rectifying frames from the videos based on estimated camera parameters to obtain rectified videos;
generating a preliminary report of detected anomalies with an anomaly engine;
generating a structured data file that combines environment data, location data, tracking data, and depth data obtained from the rectified videos by a summarizing engine; and
generating an anomaly report from the preliminary report by a machine learning model based on an instruction code generated with the structured data file, wherein the anomaly report is used for performing downstream tasks.

9. The system of claim 8, wherein generating the structured data file further comprises utilizing a vision-language model of the summarizing engine to extract the environment data from detected objects from the rectified videos.

10. The system of claim 8, wherein generating the structured data file further comprises utilizing an open vocabulary detector of the summarizing engine to extract the location data from detected objects from the rectified videos.

11. The system of claim 8, wherein generating the structured data file further comprises utilizing a multi-object tracker of the summarizing engine to extract the tracking data from detected objects from the rectified videos.

12. The system of claim 8, wherein generating the structured data file further comprises utilizing a depth model of the summarizing engine to extract the depth data from the rectified videos.

13. The system of claim 8, further comprising continuously training the summarizing engine with the anomaly report and simulated examples generated from videos obtained in real time by a simulation engine.

14. The system of claim 8, further comprising controlling an autonomous actor to resolve issues caused by anomalies detected based on the anomaly report through autonomous decision making.

15. A non-transitory computer program product comprising a computer-readable storage medium including a program code, wherein the program code when executed on a computer causes the computer to perform operations including:
removing distortion from videos by rectifying frames from the videos based on estimated camera parameters to obtain rectified videos;
generating a preliminary report of detected anomalies with an anomaly engine;
generating a structured data file that combines environment data, location data, tracking data, and depth data obtained from the rectified videos by a summarizing engine; and
generating an anomaly report from the preliminary report by a machine learning model based on an instruction code generated with the structured data file, wherein the anomaly report is used for performing downstream tasks.

16. The non-transitory computer program product of claim 15, wherein generating the structured data file further comprises utilizing a vision-language model of the summarizing engine to extract the environment data from detected objects from the rectified videos.

17. The non-transitory computer program product of claim 15, wherein generating the structured data file further comprises utilizing an open vocabulary detector of the summarizing engine to extract the location data from detected objects from the rectified videos.

18. The non-transitory computer program product of claim 15, wherein generating the structured data file further comprises utilizing a multi-object tracker of the summarizing engine to extract the tracking data from detected objects from the rectified videos.

19. The non-transitory computer program product of claim 15, wherein generating the structured data file further comprises utilizing a depth model of the summarizing engine to extract the depth data from the rectified videos.

20. The non-transitory computer program product of claim 15, further comprising controlling an autonomous actor to resolve issues caused by anomalies detected based on the anomaly report through autonomous decision making.
